(19) United States
(12) Patent Application Publication
(10) Pub. No.: US 2014/0274224 A1
(43) Pub. Date: Sep. 18, 2014

(54) MANAGING POWER CONSUMPTION ON AN ELECTRONIC DEVICE

(71) Applicant: Mimecast North America Inc., Waltham, MA (US)

(72) Inventors: Mounil Patel, Waltham, MA (US); David Goldberg, Sherborn, MA (US)

(73) Assignee: Mimecast North America Inc., Waltham, MA (US)

(21) Appl. No.: 13/829,043

(22) Filed: Mar. 14, 2013

(51) Int. Cl. H04W 52/02

(52) U.S. Cl. CPC H04W 52/0261
USPC 455/574

(57) ABSTRACT

In one aspect, in general, a method includes, based on a first indication of an amount of battery life of a battery-powered device, calculating a first polling interval for an electronic communication application running on the battery-powered device.

### BACKGROUND

This description relates to managing power consumption on an electronic device.

Electronic devices consume power from a power source such as a battery. Some operations, such as communication over a network, may have a high power consumption relative to other operations of the electronic device.

### SUMMARY

In one aspect, in general, a method includes, based on a first indication of an amount of battery life of a battery-powered device, calculating a first polling interval for an electronic communication application running on the battery-powered device.

Implementations may include one or more of the following features. The first polling interval is calculated based on a stored polling profile. The electronic communication application is an email client. The method includes receiving a second indication of an amount of battery life of the battery-powered device, the second indication indicating a smaller amount of battery life than the first indication, and based on the second indication, calculating a second polling interval for the electronic communication application, the second polling interval being less frequent than the first polling interval. The first polling interval is calculated based on a frequency at which the electronic communication application receives communications. The first polling interval is calculated based on a user preference indicating a ratio of battery life to polling frequency. The first polling interval is calculated based on an indication of a communications network to which the battery-powered device is connected. The first polling interval is calculated based on an indication of signal strength of a connection of the battery-powered device to a communications network. The method includes transmitting a query to another device at a time determined by the polling interval. The first polling interval is calculated based on an application of the first indication to a non-linear function. The first polling interval is calculated based on an application of the first indication to a linear function. The first polling interval is calculated based on an application of the first indication to a step function. The first polling interval is calculated based on an application of the first indication to a function containing a constant value. The constant value is determined based on at least one characteristic of the battery-powered device. The first polling interval is calculated based on a frequency of manual polling initiated by a user of the battery-powered device. The method includes calculating a second polling interval based on a change in a characteristic of the battery-powered device.

These and other aspects, features, and implementations, and combinations of them, may be expressed as apparatus, methods, methods of doing business, means or steps for performing functions, components, systems, program products, and in other ways.

Other aspects, features, and advantages will be apparent from the description and the claims.

### DESCRIPTION

FIG. 1 shows an electronic device and associated components.

FIG. 2 shows a portion of a user interface.

FIG. 3 shows a flowchart.

FIG. 4 shows computing devices.

Some applications running on battery-powered devices (e.g., mobile devices such as smartphones) run a timed poll on the device to query a server at regular intervals. The query could be for communications such as messages, updates, or any other data that can be received from the server. For example, the application could be an email client, and the server could be an email server at which a user of the device has an email account. If the email server is polled too frequently, the battery may be drained too quickly. If the server is polled too infrequently, battery life is better maintained but communications might take unacceptably long to arrive to the device.

These factors can be balanced by varying the polling interval based on the battery level. When a battery has a high percentage of life remaining, the interval can be short, and the interval can be increased as the battery is drained. The intervals could be determined based on a linear or non-linear polling curve which can be adapted to profiles describing battery charge behavior. A user could also select one of several polling interval curves which allow users to trade battery life for polling frequency.

FIG. 1 shows an electronic device 100 and associated components. This electronic device 100 is a mobile device (such as a smartphone) that is powered by a battery 102. The electronic device also has a transceiver 104 that can be used to send data to and receive data from resources available on a network 110. For example, the device 100 may send data to and receive data from a server 120 that also communicates using the network 110. The network 110 can be any communications network that can be used by electronic devices to communicate, for example, the Internet.

In some examples, the device 100 regularly sends communications to the server 120. By “regularly,” we mean, for example, that the device 100 sends communications automatically based on a predefined schedule or other defined plan for sending communications. Regularly could, but does not necessarily, mean at identical intervals. For example, the server 120 may be an email server, and the device 100 may send a query 130 to the server requesting any new messages (sometimes referred to as polling the server). In response to the query 130, the server 120 may send one or more messages 132 to the device 100. The query 130 may be generated by an application 106 running (e.g., executing) on the device. For example, the application may be an email application. Other examples of the application could be an instant message client, a weather application, a game (e.g., a game that includes a poll to see if an other player has moved), a social media application, a software update application, a news feed application, or any application where the software on the device waits for and react to messages from another person or device.

The transceiver 104 enables the device 100 to communicate wirelessly with the network. In some implementations, e.g., if the device 100 is a smartphone, the transceiver 104 may operate using a mobile communications standard, of which there are many known by names such as 3G, 4G, LTE, 1xRTT, and WiMAX, among others. In some implementations, the transceiver 104 may operate using a wireless network standard, such as 802.11 or another wireless network standard. In some implementations, the device 100 has multiple transceivers 104.

The transceiver 104 draws power from the battery 102 of the device 100. In some examples, the transceiver 104 draws more power from the battery 102 when communicating with resources on the network 110. For example, when the device 100 sends a query 130 to the server 120, the transceiver 104 consumes more power than when the transceiver 104 is idle, i.e., not communicating with resources on the network 110.

The frequency at which the application 106 sends queries 130 to the server 120 can vary based on the remaining life (e.g., remaining charge) of the battery 102. For example, when the battery 102 is mostly or fully charged, the application 106 can send queries 130 at a high frequency, e.g., once a minute. When the battery 102 is mostly depleted, the application 106 can send queries 130 at a lower frequency, e.g., once every fifteen minutes. In this way, the frequency at which the server 120 is polled has a relationship to a characteristic of the energy consumption of the device 100.

In some implementations, the frequency of polling can be determined by a polling profile 108. The polling profile 108 can contain any data relevant to the relationship between polling frequency (sometimes called a polling interval) and energy consumption. An application 106 that engages in polling a server 120 (or other network resource) can consult the polling profile 108 to determine a frequency of polling. As the application 106 polls the server 120, the application 106 can consult the polling profile 108 to calculate a polling frequency on an ongoing basis. For example, the application 106 can consult the polling profile after each time the application 106 sends a query 130 to the server 120 to re-calculate the polling interval.

In some examples, the polling profile 108 contains data pertaining to a relationship between polling frequency and battery life. The relationship could be expressed as a curve, for example, a linear or non-linear curve. For example, a linear curve could be defined according to the following equation:

polling frequency=C/battery life (1)

In the example of equation (1), the polling frequency has a linear relationship to the remaining battery life. For example, if the polling frequency is defined in minutes between queries, the battery life is defined as a percentage, and the constant is 0.5, then a battery life of 50% (0.5) would result in a polling frequency of every minute, while a battery life of 10% (0.1) would result in a polling frequency of every five minutes.

The linear curve could have a minimum or maximum bound. For example, the polling frequency could be defined according to the following equation:

polling frequency=min(1,C/battery life) (2)

In the example of equation (2), the polling frequency will be no more than once a minute. For example, assuming the same units as equation (1), a battery life of 100% or 75% or 55% would result in a polling frequency of once a minute, while a battery life of 10% would result in a polling frequency of every five minutes.

The polling frequency could also be defined by a non-linear curve. For example, the polling frequency could be defined according to the following equation:

polling frequency=C/battery lifê2 (3)

In the example of equation 3, a battery life of 50% would result in a polling frequency of once every two minutes, a battery life of 20% would result in a polling frequency of once every 12.5 minutes, and a battery life of 10% would result in a polling frequency of every fifty minutes. In this way, the polling frequency drops more rapidly as the battery life approaches zero.

The polling frequency could also be defined by a step function. For example, the polling frequency could be defined according to the following equation:

polling frequency=(battery life>=50%,one minute),(battery life<50%,five minutes) (4)

In the example of equation (4), a battery life of 50% or greater would result in a polling frequency of once every minute, while a battery life of less than 50% would result in a polling frequency of once every five minutes.

In some examples, the polling profile 108 contains data pertaining to a relationship between polling frequency and a communications network. As described above, the device 100 may engage in network communications using one of several protocols. For example, the device 100 may be capable of engaging in network communications using a 802.11 (WiFi) network as well as a 4G mobile communications network. Communications using one network, e.g., 4G, may consume more battery power than communications using another network, e.g., WiFi. The polling profile 108 can indicate that the polling frequency when the device 100 is connected to the 4G network should be lower than the polling frequency when the device 100 is connected to the WiFi network. The polling frequency could be expressed as a percentage (e.g., when connected to 4G, reduce polling frequency by 50%), or the polling frequency could be expressed as an absolute value (e.g., when connected to 4G, polling frequency will not exceed once every five minutes), or the polling frequency could be expressed as some other kind of value.

In some examples, the polling profile 108 contains data pertaining to a relationship between polling frequency and communications network signal strength. For example, the transceiver 104 may consume more power when it communicates wirelessly using a weak wireless carrier signal. For example, the signal may be weak because a remote device, such as a wireless hub or cellular tower, is at a relatively far distance from the device. The polling profile 108 can indicate that the polling frequency when the device 100 is connected to a network with a weak signal should be lower than the polling frequency when the device 100 is connected a network with a strong signal. The relationship between the polling frequency and communications strength could be expressed by an equation such as any of equations (1) through (4), e.g., substituting signal strength for battery life.

Any of the above relationships between polling frequency and characteristics pertaining to energy consumption could be used independently to calculate a polling frequency, or some or all of them could be combined to calculate a polling frequency. For example, some devices 100 may be configured to only use information pertaining to battery life when calculating a polling frequency, while other devices 100 may be configured to only use information pertaining to signal strength when calculating a polling frequency, and other devices 100 may be configured to use multiple types of information stored in the polling profile 108 when calculating a polling frequency.

In some implementations, the device 100 provides a user interface 140 enabling a user 150 to configure the polling profile 108. FIG. 2 shows an example view 200 of a portion of the user interface 140. The user interface 140 includes a slider 202 which can be adjusted by a user to indicate a ratio of battery life to polling frequency. If the user 150 moves the slider 202 closer to a position 204 to the left, the polling frequency can be weighted in favor of higher polling frequency (and thus potentially lower battery life). If the user 150 moves the slider 202 closer to a position 206 to the left, the polling frequency can be weighted in favor of lower polling frequency (and thus potentially higher battery life). In some implementations, the user 150 moves the slider 202 using an input device of the device 100, e.g., an input device such as a touchscreen. In some implementations, the constant value C shown in equations (1) through (4) can be adjusted based on the position of the slider 202.

Activities of the user 150 can be used to configure the polling profile 108 independent of the user's interaction with the user interface 140. For example, the application 106 can record information describing how frequently the user 150 sends or receives communications. If the user 150 frequently sends or receives communications, then the polling profile can indicate a relatively high polling frequency, since a query 130 to a server 120 is likely to result in a response that includes new communications. If the user 150 infrequently sends or receives communications, then the polling profile can indicate a relatively low polling frequency, since a query 130 to a server 120 is unlikely to result in a response that includes new communications. In some implementations, the constant value C shown in equations (1) through (4) could be adjusted based on how frequently the user 150 sends or receives communications. In some implementations, a polling interval can be determined based on how frequently the user 150 engages in manual polling for new data. For example, an application 106 may enable the user 150 to initiate manual polling, e.g., a manual check for email. The polling interval can be calculated based on this behavior, such that more frequent polling interval will be used for devices operated by users who manually check for data frequently.

FIG. 3 is a flowchart showing an example process 300. The process 300 can be carried out, for example, by the device 100 shown in FIG. 1.

A first indication of remaining battery life of a battery-powered device is received 302. For example, the battery could be the battery 102 shown in FIG. 1.

A first polling interval for an electronic communication application running on the battery-powered device is calculated 304 based on the first indication. The polling interval (e.g., the amount of time between queries communicated by the application) can be calculated based on a stored polling profile, e.g., the polling profile 108 shown in FIG. 1. In some implementations, the first polling interval is calculated based on an application of the first indication to a non-linear curve. In some examples, the first polling interval is calculated based on a frequency at which the electronic communication application receives communications. In some examples, the first polling interval is calculated based on a user preference indicating a ratio of battery life to polling frequency. In some examples, the first polling interval is calculated based on an indication of a communications network to which the battery-powered device is connected. In some examples, the first polling interval is calculated based on an indication of signal strength of a connection of the battery-powered device to a communications network.

In some implementations, a second indication of remaining battery life of the battery-powered device is received, such that the second indicating a shorter battery life than the first indication. Based on the second indication, a second polling interval for the electronic communication application can be calculated, such that the second polling interval being less frequent than the first polling interval.

FIG. 4 is a block diagram of example computing devices 400, 450. For example one computing device 400 could be the server 120 shown in FIG. 1, and one computing device 500 could be the device 100 shown in FIG. 1.

One computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 (e.g., a computer monitor or television) coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, memory on processor 402, or a propagated signal.

The high speed controller 408 manages bandwidth-intensive operations for the computing device 400, while the low speed controller 412 manages lower bandwidth-intensive operations. Such allocation of functions is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device, such as mobile computing device 450. Each of such devices may contain one or more of computing device 400, 450, and an entire system may be made up of multiple computing devices 400, 450 communicating with each other.

The mobile computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

The processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, memory on processor 452, or a propagated signal that may be received, for example, over transceiver 468 or external interface 462.

The mobile computing device 450 may communicate wirelessly through communication interface 466, e.g., an Ethernet card, a serial communication device, e.g., an RS-232 port, and/or a wireless interface device, e.g., an 802.11 card, a 3G wireless modem, a 4G wireless modem, or another interface, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (e.g., the transceiver 104 shown in FIG. 1). In addition, GPS (Global Positioning System) receiver module 470 may provide additional navigation- and location-related wireless data to device 450, which may be used as appropriate by applications running on device 450.

The mobile computing device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, and so forth) and may also include sound generated by applications operating on device 450.

The mobile computing device 450 may be implemented in a number of different forms, as shown in the figure. For example, it may be implemented as a cellular telephone 480. It may also be implemented as part of a smartphone 482, personal digital assistant, or other similar mobile device.

A server (e.g., the server 120 shown in FIG. 1) can be realized by instructions that upon execution cause one or more processing devices to carry out processes relevant to the functions described above. Such instructions can comprise, for example, interpreted instructions such as script instructions, or executable code, or other instructions stored in a computer readable medium. A server can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although example devices have been described in FIG. 4, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a physical device such as a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server (e.g., forming a portion of a communications facility 100) is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

Other implementations are within the scope of the following claims.

1. A method comprising
based on a first indication of an amount of battery life of a battery-powered device, calculating a first polling interval for an electronic communication application running on the battery-powered device.

2. The method of claim 1 in which the first polling interval is calculated based on a stored polling profile.

3. The method of claim 1, in which the electronic communication application is an email client.

4. The method of claim 1 comprising receiving a second indication of an amount of battery life of the battery-powered device, the second indication indicating a smaller amount of battery life than the first indication,
based on the second indication, calculating a second polling interval for the electronic communication application, the second polling interval being less frequent than the first polling interval.

5. The method of claim 1, in which the first polling interval is calculated based on a frequency at which the electronic communication application receives communications.

6. The method of claim 1, in which the first polling interval is calculated based on a user preference indicating a ratio of battery life to polling frequency.

7. The method of claim 1, in which the first polling interval is calculated based on an indication of a communications network to which the battery-powered device is connected.

8. The method of claim 1, in which the first polling interval is calculated based on an indication of signal strength of a connection of the battery-powered device to a communications network.

9. The method of claim 1, comprising transmitting a query to another device at a time determined by the polling interval.

10. The method of claim 1 in which the first polling interval is calculated based on an application of the first indication to a non-linear function.

11. The method of claim 1 in which the first polling interval is calculated based on an application of the first indication to a linear function.

12. The method of claim 1 in which the first polling interval is calculated based on an application of the first indication to a step function.

13. The method of claim 1 in which the first polling interval is calculated based on an application of the first indication to a function containing a constant value.

14. The method of claim 1 in which the constant value is determined based on at least one characteristic of the battery-powered device.

15. The method of claim 1, in which the first polling interval is calculated based on a frequency of manual polling initiated by a user of the battery-powered device.

16. The method of claim 1, comprising calculating a second polling interval based on a change in a characteristic of the battery-powered device.

17. A system comprising:
a battery-powered device configured to, based on a first indication of an amount of battery life of a battery-powered device, calculate a first polling interval for an electronic communication application running on the battery-powered device.

18. A computer readable storage device storing a computer program product comprising machine-readable instructions that, when executed, cause a computer system to carry out operations comprising:
based on a first indication of an amount of battery life of a battery-powered device, calculating a first polling interval for an electronic communication application running on the battery-powered device.
